(19) United States
(12) Patent Application Publication
(10) Pub. No.: US 2012/0176494 A1
(43) Pub. Date: Jul. 12, 2012

(54) SYSTEM AND METHOD FOR VIRTUAL RANGE ESTIMATION

(76) Inventors: Yishay Kamon, Yuvalim (IL); Omri Peleg, Mevaseret Zion (IL); Gil Briskin, Petach Tilva (IL); Nir Hoffman, Nofit (IL)

(21) Appl. No.: 13/393,228

(22) PCT Filed: Aug. 24, 2010
(86) PCT No.: PCT/IB10/53797

§ 371 Date: Mar. 15, 2012

(30) Foreign Application Priority Data
Aug. 30, 2009 (IL) 200637

(51) Int. Cl. G06K 9/00; H04N 7/18

(52) U.S. Cl. 348/135; 382/106; 348/E07.085

(57) ABSTRACT

A system and method for estimating the range to a target is based on logging images and related information as a vehicle is moving. When the vehicle is at a first observation point and an event of interest occurs at a target location, the log can be accessed to provide an image and related information of the target from a time in the past. This logged information provides a prior observation point, or in other words a second observation point, to use for triangulation, eliminating the need and time required to move the vehicle and acquire a second observation point. Using the current information from the first observation point, and the logged information of a prior observation point, triangulation can be used to estimate the range from the current observation point to the target.

### FIELD OF THE INVENTION

The present embodiment generally relates to the field of image processing, and in particular, it concerns a method for estimating the range to a target.

### BACKGROUND OF THE INVENTION

Estimating the range to a target point of interest is an important area of research with critical practical applications. In particular, many systems need methods to estimate ranges from on-board sensors to a target. A variety of conventional techniques is known for performing range estimation.

Range estimation can be done using active techniques, as described by Patrick J. Donoghue ET. AL. in U.S. Pat. No. 7,359,038 for Passive determination of ground target location. Active techniques use a laser or other detectable signal to determine the distance to a target point from an observation point. Donoghue ET. AL. teaches the advantages and disadvantages of active techniques, and why there is a need for passive techniques for range estimation. Donoghue et al further teaches a technique which includes using a known reference point and a digital terrain elevation database (also known as a digital terrain map, or DTM) to estimate the location of a ground target.

A summary of conventional techniques for passive range estimation is taught by William C. Choate ET. AL. in U.S. Pat. No. 5,422,828 for Method and system for image-sequence-based target tracking and range estimation. This patent teaches a method of tracking targets across a sequence of images making use of the known sensor motion to generate “expected images” that are then used to establish a reliable correspondence and track the targets across the image sequence. With this correspondence, methods can estimate the range of the target from the vehicle.

An accepted solution for finding the range from an observation point to a target point is to use triangulation. Triangulation requires at least two observations of a target of interest, the distance between observations, and the angles from the observation points to the target of interest. Triangulation is the process of determining the location of a point by measuring angles to it from known points at either end of a fixed baseline, rather than measuring distances to the point directly. The point can then be fixed as the third point of a triangle with one known side and two known angles.

Referring to FIG. 1, a diagram of conventional triangulation, at a first observation point 102 an image of a target 104 is captured along with the angle 110 to the target. The vehicle then moves a given distance 114 to a second observation point 108 and captures a second image of the target 104 along with a second angle 112 from to the target. Using known geometric formulas, the distance 116 from the second observation point to the target area can be determined.

One example of the use of this technique can be seen in FIG. 1 where a tank at location 102 is fired on from a target 104 at a distant location. Sensors, such as cameras, on the tank can image the target 104 when this event of interest occurs. Then the tank needs to move to second observation point 108 to capture a second image. One of the problems with this technique is that, in the time it takes the tank to travel from the first to the second observation point, the target can move from the location at which it was first imaged. Conventional solutions to problems such as this are focused on reducing the amount of time between observations. The faster a second image can be taken, the less time the target has to move from the location in which it was first imaged, increasing the chances of determining the distance to the target. A difficulty with this approach is that the sooner the second image is taken after the first image, the shorter the distance will be between the second observation point and the first observation point. A shorter the distance between observation points the more difficult it is to determine an accurate distance from an observation point to the target.

Another conventional solution to range estimation is to use a single observation point and a digital terrain map (DTM). A digital terrain map, also known as a digital terrain model (DTM), or digital elevation model (DEM), is a digital representation of ground surface topography or terrain. Given a single observation point, a vector to a target, and a DTM, it is possible to estimate the range from the observation point to a target. The observation dataset includes information on where on the DTM the observation point is located (where are you?), and the vector, which includes direction and elevation (where are you looking?), to a target of interest. The range is calculated from the observation point, along the vector toward the target area, using the intersection to a point on the DTM.

Referring to FIG. 2, a diagram of conventional range estimation using a DTM includes a DTM 200, an observation point 202, and a target 204. The location of an observation point 202 is located on the DTM 200. Given a vector 203 to the target 204, the intersection of the vector 203 and the DTM 200 can be determined and then the range from the observation point 202 to the target 204 can be calculated.

One problem with range estimation using a DTM is the limitation due to inaccuracies in the location of the observation point on the DTM. On-board guidance systems, for example inertial guidance systems and global positioning systems (UPS) are accurate with given limitations. In a case where there is a shallow (for example, near horizontal) angle to a target area of interest, a small inaccuracy in the angle of the vector to the target can result in a large error in estimating the range. The amount of inaccuracy and resulting amount of error in range will depend on the specific application of the technique.

There is therefore a need for a system and method to estimate the range from an observation point to a target when an event of interest occurs, without requiring time for movement of the vehicle. There is also a need for a system and method for improving the accuracy of observation location information for use in range estimation using a digital terrain map.

### SUMMARY

According to the teachings of the present embodiment there is provided a method for estimating the range to a target including: providing an observation log including a plurality of observation datasets, each of the observation datasets including: at least one image; the location at which the at least one image was captured; and the orientation of each of the at least one image; identifying a target in an image corresponding to a first observation dataset; searching the observation log for a prior observation dataset, wherein an image of the prior observation dataset includes the target; and calculating, using data from the first observation dataset in combination with data from the prior observation dataset, using triangulation to estimate the range between the location of the first observation dataset and the target.

In an optional embodiment, the observation dataset further includes the time that the dataset was captured. In another optional embodiment, the observation log is searched backwards in time starting with the most recent observation dataset. In another optional embodiment, when searching fails to identify a prior observation dataset, the range to the target is calculated in combination with a digital terrain map (DTM). In another optional embodiment, the images are provided by a vehicle mounted image capture device and the observation log is updated with new observation datasets as the scene around the vehicle changes.

According to the teachings of the present embodiment there is provided a method to determine an accurate location of an observation dataset on a digital terrain map, the method including: providing an observation log including a plurality of observation datasets, each of the observation datasets including: at least one image; the location at which the at least one image was captured; and the orientation of each of the at least one image; selecting at least one ranging location in an image from a first observation dataset; searching the observation log to provide at least one prior observation dataset, wherein an image which corresponds to each of the at least one prior observation datasets includes at least one common identifiable area; and calculating using triangulation to determine an accurate location of the first observation dataset on the digital terrain map using a combination of data from the first observation dataset, data from the at least one prior observation dataset, the common identifiable area, and a digital terrain map.

In an optional embodiment, the observation dataset further includes the time that the dataset was captured. In another optional embodiment, the observation log is searched backwards in time starting with the most recent observation dataset. In another optional embodiment, selecting the at least one ranging location in the image is done randomly. In another optional embodiment, selecting the at least one ranging location in the image is done using a sparse distribution. In another optional embodiment, selecting the at least one ranging location in the image is done using a dense distribution of a plurality of ranging locations. In another optional embodiment, the method is repeated to substantially constantly maintain the accurate location of the observation dataset on the digital terrain map. In another optional embodiment, the method further includes: identifying a target in the image corresponding to the first observation dataset; generating a target vector from the location of the first observation dataset toward the target; and calculating, using the target vector from the location of the first observation dataset in combination with the digital terrain map, the estimated range between the location of the first observation dataset and the target.

According to the teachings of the present embodiment there is provided a method to determine an accurate location of an observation point on a digital terrain map, the method including: determining a plurality of ranges from an observation point to ranging locations, thereby creating a range map; and correlating the range map to the digital terrain map to determine an accurate location of the observation point on the digital terrain map. In an optional embodiment, the plurality of ranges is a sparse distribution of ranges. In another optional embodiment, the plurality of ranges is a dense distribution of ranges. In another optional embodiment, the method further includes generating a target vector from the observation point toward a target; and calculating, using the target vector from the observation point in combination with the digital terrain map, the estimated range between the observation point and the target. In another optional embodiment, the ranges are determined using a range finding device.

According to the teachings of the present embodiment there is provided a system for estimating the range to a target including: a vehicle; an image capture system including at least one image capture device configured to provide images, the image capture system mounted on the vehicle; a navigation system configured to provide location and orientation information; and a processing system, operationally connected to the image capture system and operationally connected to the navigation system, the processing system including at least one processor configured to: generate observation datasets which include: at least one image; the location at which the at least one image was captured; and the orientation of each of the at least one image; store observation datasets to an observation log; identify a target in an image corresponding to a first observation dataset; search the observation log for a prior observation dataset, wherein an image of the prior observation dataset includes the target; and calculate, using data from the first observation dataset in combination with data from the prior observation dataset, using triangulation to estimate the range between the location of the first observation dataset and the target.

In an optional embodiment, the image capture device is a panoramic camera. In an optional embodiment, the image capture device is a charge-coupled device (CCD). In an optional embodiment, the image capture device is a forward-looking infrared device (FLIR). In an optional embodiment, the navigation system provides the location and orientation information as geospatial data. In an optional embodiment, the navigation system includes an inertial navigation system (INS). In an optional embodiment, the navigation system includes a global positioning system (GPS) based device. In an optional embodiment, the observation dataset further includes the time that the dataset was captured. In an optional embodiment, the at least one processor is further configured to search the observation log backwards in time starting with the most recent observation dataset. In an optional embodiment, the at least one processor is further configured, when the searching fails to identify a prior observation dataset, to calculate the range to the target in combination with a digital terrain map (DTM). In an optional embodiment, the vehicle is configured with an image capture device and the processing system is further configured to update the observation log with new observation datasets as the scene around the vehicle changes.

In an optional embodiment, the system is further configured to determine an accurate location of an observation dataset on a digital terrain map, including: a digital terrain map; and the processing system further configured to: select at least one ranging location in an image from the first observation dataset; search the observation log to provide at least one prior observation dataset, wherein an image which corresponds to each of the at least one prior observation datasets includes at least one common identifiable area; and calculate using triangulation to determine an accurate location of the first observation dataset on the digital terrain map using a combination of data from the first observation dataset, data from the at least one prior observation dataset, the common identifiable area, and a digital terrain map. In an optional embodiment, selecting the at least one ranging location in the image is done randomly. In an optional embodiment, selecting the at least one ranging location in the image is done using a sparse distribution. In an optional embodiment, selecting the at least one ranging location in the image is done using a dense distribution of a plurality of ranging locations. In an optional embodiment, the processing is repeated to substantially constantly maintain the accurate location of the observation dataset on the digital terrain map.

In an optional embodiment, system is further configured to: generate a target vector from the location of the first observation dataset toward the target; and calculate, using the target vector from the location of the first observation dataset in combination with the digital terrain map, the estimated range between the location of the first observation dataset and the target.

### BRIEF DESCRIPTION OF FIGURES

The embodiment is herein described, by way of example only, with reference to the accompanying drawings, wherein:

FIG. 1 is a diagram of conventional triangulation.

FIG. 2 is a diagram of conventional range estimation using a DTM.

FIG. 3 is a diagram of a method for virtual range estimation.

FIG. 4 is a flowchart of a method for virtual range estimation.

FIG. 5 is a flowchart of a method of accurately determining the location of an observation dataset on a digital terrain map.

FIG. 6 is a system for estimating the range to a target.

### DETAILED DESCRIPTION

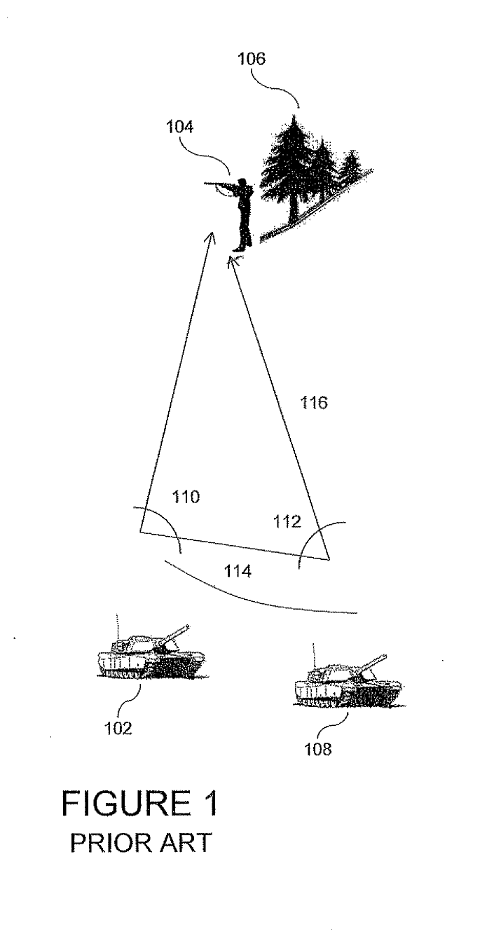

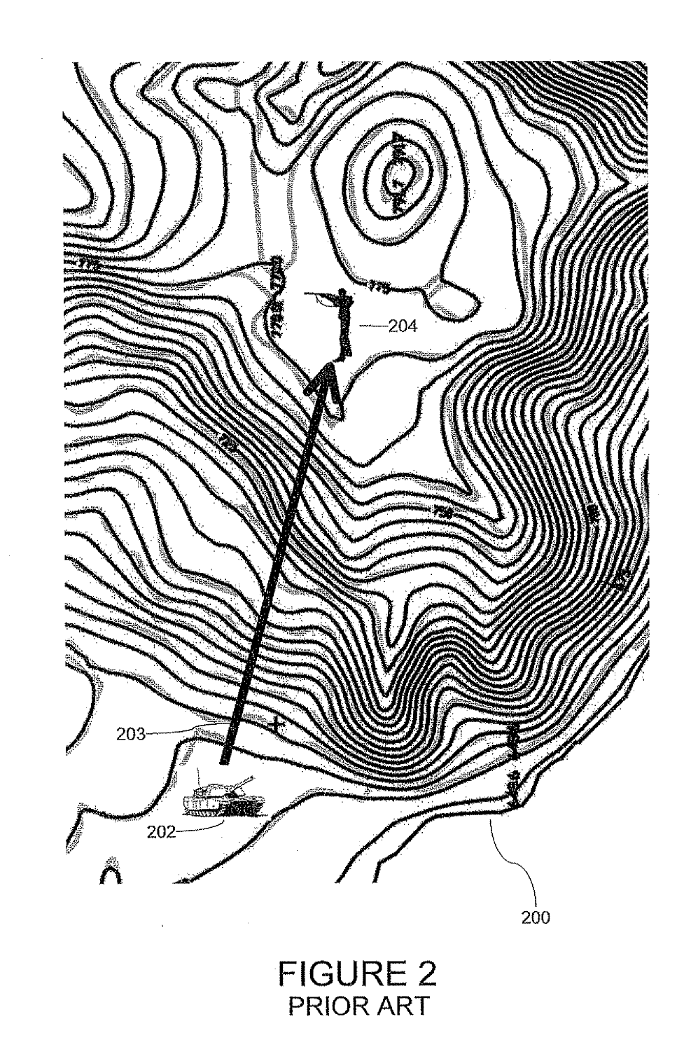

### FIGS. 1 to 6

The principles and operation of this system and method according to the present implementation may be better understood with reference to the drawings and the accompanying description.

The accepted solution for finding the range from an observation point to a target is to use triangulation. When an event of interest occurs, conventional techniques capture an image of a target of interest, and then the sensor, or generally known in this context as a vehicle, moves to a second observation point and captures a second image of the target of interest, as well as measuring or calculating other necessary data to perform the triangulation. As described in the background section of this document, and diagrammed in FIG. 1, this technique has limitation and problems. It is preferable to estimate the distance to the target when the event of interest occurs, without the delay necessary to move to a second observation point.

The innovative method of one implementation of the current invention is based on logging images and related information as the vehicle is moving. When the vehicle is at a first observation point and an. event of interest occurs at a target location, the log can be accessed to provide an image and related information of the target from a time in the past. This logged information provides a prior observation point, or in other words a second observation point, to use for triangulation, eliminating the need and time required to move the vehicle and acquire a second observation point. Using the current information from the first observation point, and the logged information of a prior observation point, triangulation can be used to estimate the range from the current observation point to the target.

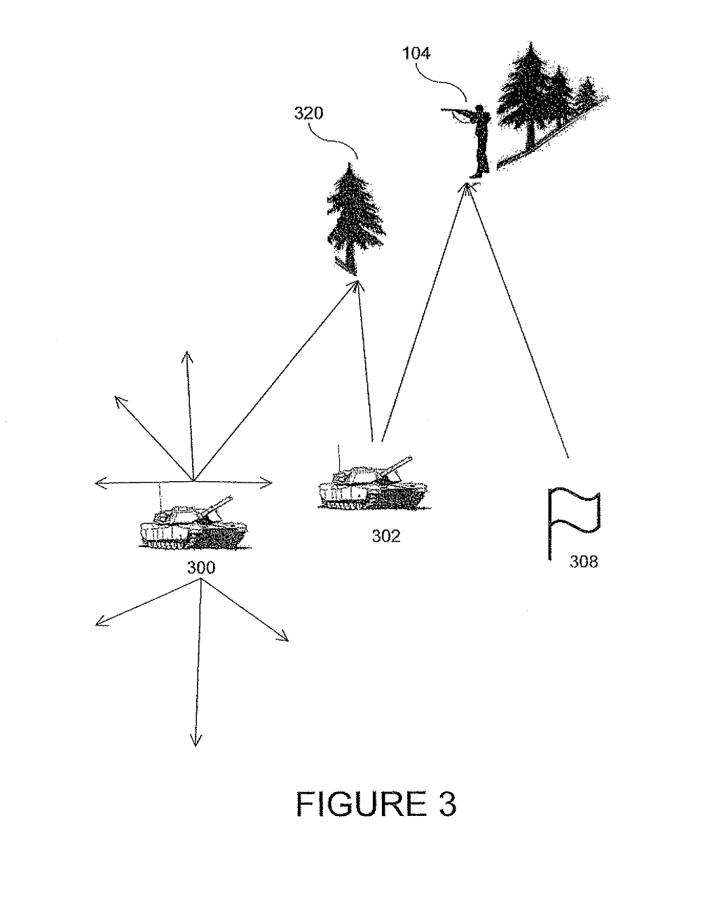

Referring to FIG. 3, a diagram of a method for virtual range estimation, a vehicle at location 300 moves to location 302. While the vehicle is moving, it logs observation datasets that include captured images and image related information such as the location of the vehicle and orientation of the captured image. In the context of this document, vehicle refers to the platform that captures an observation dataset when an event of interest occurs. When the vehicle is at location 302 an event of interest is seen at a location that is designated as the target 104. In the context of this document, target refers to a location such as an area, region, or point where an event of interest occurs. The target area may vary in size depending on the application and the circumstances of the event of interest. A target vector is a three-dimensional angle from an observation point to a target. Using the method of this implementation, it is not necessary for the vehicle to move to location 308 to capture a second observation dataset of the target of interest. Instead, the vehicle can use the information logged when it was at location 300 to provide a second observation dataset and estimate the range to the target. This method is referred to as virtual range estimation. The term virtual is used in this context to refer to estimating the range to a target by providing a second observation point from previously logged observation datasets. This second observation point is derived from stored data, and hence called virtual, as the technique eliminates the need to acquire an additional observation point after the event of interest.

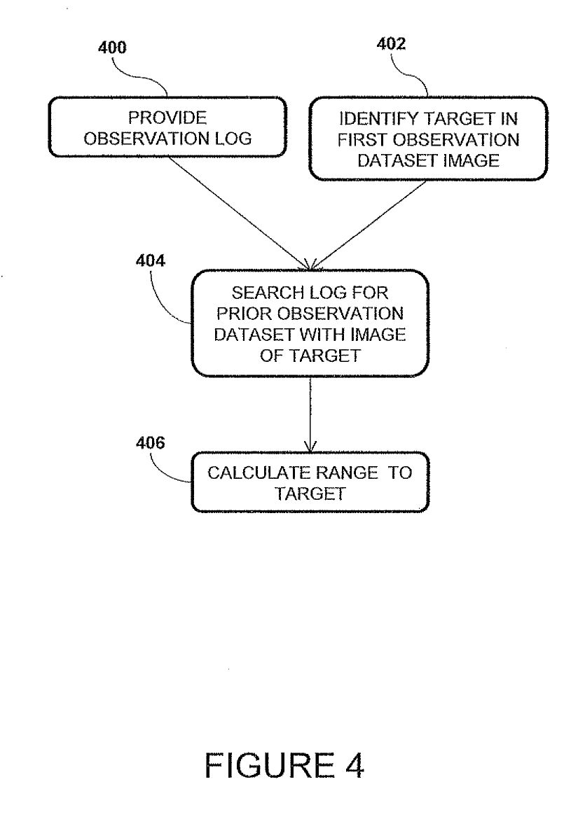

Referring to FIG. 4, a flowchart of a method for virtual range estimation, the method begins by providing an observation log (also referred to in this document as simply a “log”) containing observation datasets, shown in block 400. Each observation dataset includes one or more images, the location at which each image was captured, and the orientation of the captured image. The observation dataset can optionally include the time the dataset was captured, data about the image, and related information. In this context, location refers to a three-dimensional location in the world, or optionally to a reference location. Orientation refers to a three-dimensional vector providing the direction in which the image was captured. The physical location of the vehicle when a dataset is captured is referred to as an observation point. Hence, a first observation point corresponds to the location at which a first observation dataset was captured. Information corresponding to each of the plurality of images is referred to as image data. Note that image data also refers to information about the physical location of the vehicle, orientation of the sensor, image capture device, and additional related information. In this document, a log is defined as any way that a plurality of images and image data can be recorded for a given length of time, and accessed for a given length of time. The log should minimally include sufficient image data to allow determination of the angle at which the image was captured, and the image data should facilitate determining the distance between observation points.

When an event of interest occurs, an observation dataset is captured. This observation dataset includes an image of the area where the event of interest occurred. The image is processed, and the location of the event of interest is designated as the target, shown in block 402. The observation dataset that includes the target provides a first observation dataset for eventual triangulation and range estimation.

If the event of interest just started, or was of short duration, the event may not have been captured in the log. In this case, one or more features the image near the event of interest can be used to identify a target. An example of a short duration event is weapons fire, in particular small arms muzzle flash. Although the flash is of a very short duration, the background near the flash location can be used to identify a target.

Image processing may be necessary to facilitate identification of a specific target in the captured image. Examples of image processing include removing interfering objects from the image, compensating for obscuring environmental conditions, calculating the center of mass or other significant indicator of the location of the target point, or otherwise processing an area of the image to derive a sufficiently precise location of the target. The precision necessary is determined by the implementation of the method and the specifics of the system in which it is used.

After an event of interest occurs, and a target has been identified, the observation log is searched to find a prior observation dataset with an image that includes the identified target, shown in block 404. Such a prior observation set provides a second observation point with the information necessary for triangulation to estimate the range to the target.

According to a non-limiting example of using the background near an event of interest, is the case where small arms fire comes from a shooter hiding in a grove of trees. The muzzle flash from the gun of the shooter is captured in the image taken when the vehicle is at a first observation point. The background near the muzzle flash can be analyzed and the grove of trees, a single tree, or other features can be identified as the target point. Then the log can be searched for images with the grove of trees, the single tree, or other feature, and the observation dataset where this image was captured can be used as the second observation point.

Searching methods are known in the art, and the search used depends on the specifics of the application of the method and the system in which it will be used. Searching may optionally include preprocessing or post processing of images from the log. The location of the image from the log provides a second observation point to use for triangulation. For increased precision in triangulation, it is preferable that the second observation point is chosen to subtend an angle of 5 or more degrees from the first observation point at the point of interest. The specific distances and angles depend on the application of the method. In an optional implementation, information from the observation dataset, such as navigation information, is used to manage the search process.

In one optional implementation, the log is searched backward, that is, from the time the event of interest occurs at a first observation point the log is searched backward in time to find a prior observation point that is distant from the first observation point. An implementation of a technique for searching backward through the log starts by identifying features of the target, or features around the target, in the image associated with the event of interest. These features are tracked in the image from the most recent observation dataset in the log. Feature tracking continues in images from earlier observation datasets. Depending on the application, various criteria can be used to decide when an observation dataset is sufficient to be used for triangulation and range estimation. According to a non-limiting example, when the difference between the first observation point and a prior observation point reaches a pre-defined angle, tracking is stopped and the dataset corresponding to the prior observation point is used for triangulation and range estimation.

In order to increase the efficiency of the technique, it is possible to skip observation datasets when tracking features backward through the log. It is also possible to perform adaptive tracking where the number of datasets skipped and direction of skipping is adjusted based on feedback from the feature tracking. According to a non-limiting example, feature tracking starts by skipping 100 datasets, then searching the image in the next dataset for matching features. If the features are found, another 100 datasets are skipped and searching is performed again. If the features are not found, the technique can continue backward in time, skipping another 100 datasets and then searching for matching features. This allows for the case where the target features were temporarily obscured in a particular number of datasets. If matching features are not found, the technique can skip forward 150 datasets and perform a search in a dataset closer to the dataset that was last successfully searched. Other variations are possible depending on the application, and will be obvious to one skilled in the art.

Given a first observation dataset, a prior observation dataset, and their corresponding image data, triangulation can be performed to estimate the range from either observation location to the target. Performing triangulation repeatedly with one or more new observation datasets or prior observation datasets can estimate the range to the target more accurately. The technique of using triangulation over multiple images is known in computer vision literature as multiple view geometry, and implementation options will be clear to one skilled in the art.

In an optional implementation, the images are provided by a vehicle mounted image capture device and the observation log is updated with new observation datasets as the scene around the vehicle changes.

The above-described method is highly effective. However, in cases where a prior observation dataset cannot be provided from the observation log, the range to the target can be calculated in combination with a digital terrain map (DTM). According to a non-limiting example, this case occurs when the vehicle reaches the top of a hill and a target is identified on the other side of the hill. In this case, the observation log does not contain any datasets for the other side of the hill. The method described above can optionally incorporate the steps described below. It should be appreciated that this technique can also be used as a standalone technique.

Conventional techniques exist to perform range estimation using digital terrain map (DTM) with a single observation point. One of the limitations to the accuracy of range estimation using a DTM is the accuracy of the positioning of the actual physical location of the observation point on the DTM. Inaccuracies of the observation point location on the DTM can lead to inaccuracies in measurement of the angle to the target, as described in the background section of this document.

The innovative method of one implementation of the current invention to determine an accurate location of an observation dataset on a digital terrain map is based on generating a range map and correlating it to a DTM. A plurality of ranges from a location of at least one observation dataset to ranging locations are determined, thereby creating a range map. This range map is correlated to a DTM to determine an accurate location of an observation dataset on the digital terrain map.

In one implementation, the accurate location of an observation dataset on a digital terrain map is based on logging observation datasets as a vehicle is in successively different locations. Using the logged information in combination with a ranging location in an image from the observation dataset, triangulation can be used to position accurately the location of the observation dataset on the DTM. When it is desired to know the range from an observation point corresponding to the location of the observation dataset, to a target that has not been logged, the accurate location of the observation point on the DTM can be used with the target vector from the observation point toward the target to estimate the range between the observation point and the target.

Conventional navigation systems of a sort suitable for this application may have an initial azimuth accuracy of 10-20 milliradians and an elevation and roll accuracy of about 3 milliradians. Initial location accuracy of a suitable GPS system may be in the range of 10-20 meters. The method of this description has been shown to provide an improved angular accuracy of about 2 milliradians for all axes and a location error of about 3 meters relative to a DTM.

To determine an accurate location of a first observation dataset, an image is captured at the first observation point and a ranging location is identified in the image. In this context, a ranging location is an area other than the target that can be identified in an image. The ranging location can include an area, region, or point and can vary in size depending on the application. The observation log is searched to provide at least one observation dataset with a captured image of the ranging location that is also in the captured image from the first observation point. The two observation points and their corresponding image data can be used in combination with the ranging location to perform triangulation and provide an accurate location of the first observation point on the DTM. Given a target area that is not in the observation log, this technique can be used to improve the accuracy of estimating the range to the target area. Using the accurate location of the first observation dataset on the DTM, a target vector from the first observation point toward the target can be used with the DTM to calculate the intersection of the target vector and the DTM, and from there estimate the range between the first observation point and the target. To position accurately the location of the observation dataset on the DTM, it is preferable to use at least 8 ranging locations. Typically, significantly more points are used. In one implementation, a sparse distribution of tens to a few hundreds of reference points is used. In another implementation, a dense distribution, typically in excess of ten thousands reference points is used, most preferably providing range data for a majority of image pixels over at least part of the current image.

Referring again to FIG. 3, a vehicle at location 300 moves to location 302. While the vehicle is moving, it logs observation datasets. When the vehicle is at first observation point 302 an event of interest is seen at target location 104. Using the method of this implementation, it is not necessary for the vehicle to move to location 308 to capture a second observation dataset of the target of interest. Instead, the vehicle has access to a DTM and can measure the target vector from location 302 toward target 104. The vehicle also needs to determine the location of a prior observation point, such as 300, on the DTM. A more accurate location of the prior observation point on the DTM facilitates a more accurate estimation of the range between the first observation point and the target.

The vehicle has access to a log of observation datasets from the time that the vehicle was at location 300. If the log contains an observation of target 104, then the method described above can be used with a prior observation dataset, such as from 300, and triangulation to the target 104. In our current case, target 104 was not previously visible to the vehicle, hence the previously described method cannot be used in this case. Instead, at least one ranging location 320 is selected from an image of the first observation dataset. The observation log is searched to provide at least one prior observation dataset, wherein an image of the prior observation dataset includes at least one of the identifiable areas. The matching ranging location is a common ranging location for the two images. The common ranging location 320 is visible from both the first observation point 302 and at least the prior observation point 300. Using data from the first observation dataset in combination with data from at least one prior observation dataset, the common identifiable area, and a DTM, triangulation is used to determine an accurate location of the first observation dataset on the DTM and to determine an accurate orientation of the first observation dataset. Using the accurate location and orientation of the first observation dataset on the DTM, an accurate target vector from the first observation point toward the target can be used with the DTM to estimate the range between the first observation point and the target.

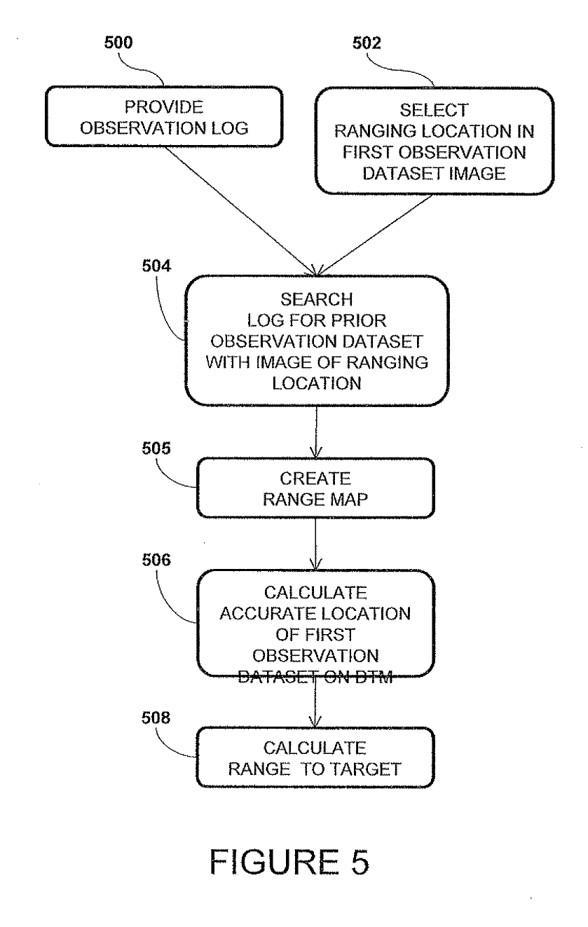

Referring to FIG. 5, a flowchart of a method of accurately determining the location of an observation dataset on a digital terrain map (DTM). Optionally the accurate location of the observation dataset on the DTM can be used to estimate more accurately the range between the location of the first observation dataset and a target. The method begins by providing an observation log, shown in block 500, a first observation dataset, and a DTM. These may be provided in any order. The image corresponding to a first observation dataset is processed to identify at least one ranging location in the image, shown in block 502. At least one ranging location can be selected randomly, or depending on the application of the method, a given selection algorithm can be used. The types of ranging locations to use can be pre-defined, such as generic features to search for, or known features in the environment in which the method is being used. Ranging locations can also be derived using techniques from machine learning to identify what features are identifiable in the environment of the system.

Next, the datasets in the observation log are searched to find at least one dataset with an image containing at least one identifiable area, shown in block 504. For each image found that contains an identifiable area, the corresponding observation dataset can be used as a second observation dataset. The first observation dataset can be used in combination with one of the second observation datasets and the ranging location to calculate the range between any of the associated points. If there is more than one second observation dataset, each of the second observation datasets can be used to calculate a range between the associated points. The calculated ranges are combined to create a range map, as shown in block 505. A range map is a collection of one or more ranges, including ranges between observation points, and ranges between observation points and identifiable areas. The range map is correlated to the DTM to locate accurately an observation dataset on the DTM, shown in block 506. In the case where the location of the observation dataset is the current location of the vehicle, the accurate location of the vehicle on the DTM has been determined. Techniques for fitting points to a DTM, such as least squares, are known in the art and other techniques will be obvious to one skilled in the art. Note that the contents of the observation log and searching algorithms are as described in the above method for estimating the range to a target.

In an optional implementation, the method of accurately determining the location of an observation dataset on a digital terrain map can be performed repeatedly to constantly maintain an accurate location of the current observation point on the DTM within a given accuracy. In this implementation, the method is performed a first time to determine accurately the location of the observation point on the DTM. The method can then be performed periodically or aperiodically to update the location of the observation point on the DTM. The amount of time between repetitions depends on the specific application of the method. In an alternate implementation, the method can use some or all of the same ranging locations from one repetition to the next repetition. This reduces or eliminates processing to identify ranging locations and search for second observation points. A measure of quality can be determined experimentally, set manually, or automatically determined as to the accuracy of using the current set of identifiable areas. When the quality of using the current set of ranging locations falls below a given level, or certain ranging locations are lost from view, additional ranging locations or a new set of ranging locations can be identified. Depending on the requirements of the application, when an event of interest occurs, this implementation can eliminate the delay between identifying the target of interest and knowing accurately where the observation point is located on the DTM.

In an optional implementation, the accurate location of the first observation dataset on the DTM can be used to estimate the range between the first observation point and a target, shown in block 508. First, a target area is identified in the image captured by the vehicle at the first observation point. The vehicle also provides image related data on the location and orientation of the captured image. Next, the image data is used in combination with the target in the image to generate a target vector from the first observation point toward the target. Using the accurate location of the first observation point on the DTM, a target vector from the first observation point toward the target can be used with the DTM to calculate the intersection of the target vector and the DTM, and from there the estimated range between the first observation point and the target can be calculated. In this manner, an accurate estimated range can be obtained even in cases where the target was not visible in images from prior observation datasets.

Note that when a DTM is used to estimate the range between the first observation point and a target it is assumed that the DTM includes both the first observation point and the target of interest. If the DTM does not include both of these locations, other methods can be used to estimate the range between the locations.

In one implementation, the previously described method uses a plurality of ranges from a location of at least one observation dataset to ranging locations to generate a range map. The ranges can be calculated from an observation log, as previously described, or provided by alternative means. In another implementation, a range finder can be used to provide a plurality of ranges. In an implementation where a device such as a range finder is used to determine ranges, the location of the observation dataset is referred to as the observation point. Preferably, at least a sparse distribution of ranges is used. In another implementation, a dense distribution of ranges is used. In another implementation, a target vector is generated from the observation point toward a target and the estimated range between the observation point and the target is calculated using the target vector in combination with the DTM.

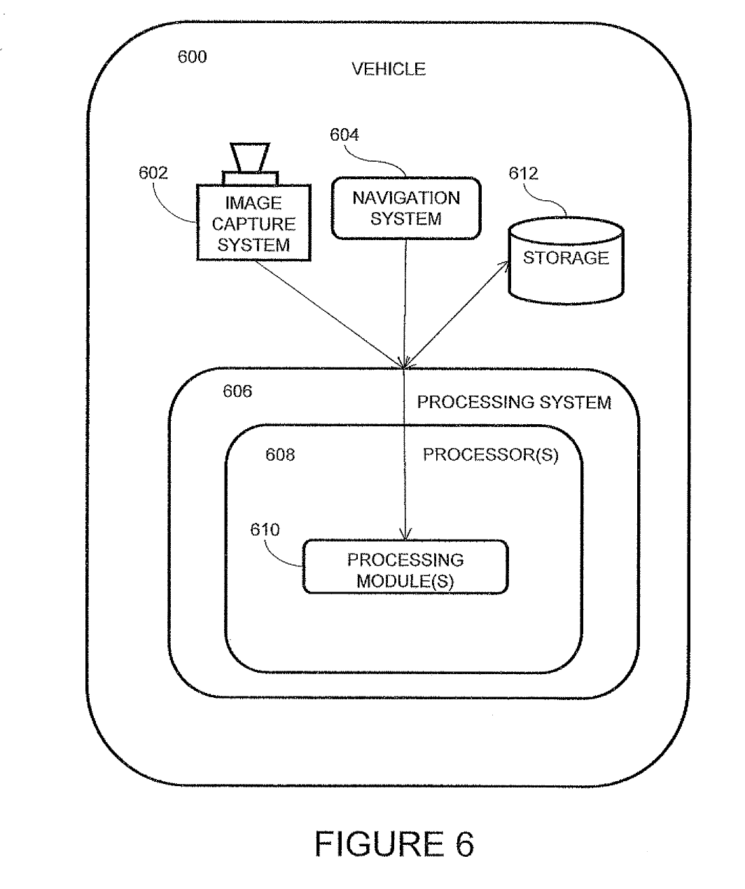

Referring to FIG. 6, a system for estimating the range to a target includes a vehicle 600, an image capture system 602, a navigation system 604, a processing system 606 including one or more processors 608 configured with one or more processing modules 610, and storage 612. A vehicle 600 is platform that captures an observation dataset when an event of interest occurs. In a preferred implementation, the vehicle is a tank. In other implementations, the vehicle can be a truck, jeep, other mobile terrestrial platform, manned aircraft, unmanned aerial vehicle (UAV), or watercraft.

The vehicle is configured with an image capture system 602. The image capture system includes one or more image capture devices configured to provide images. The image capture system can be a pre-existing system on the vehicle, or a separate system that is installed on the vehicle. A variety of image capture devices can be used depending on the application of the system. In one implementation, the image capture device is a charge-coupled device (CCD). In another implementation, the image capture device is a forward-looking infrared device (FLIR). The image capture system preferably has a wide field of view. In one implementation, the image capture system includes a panoramic sensor. A panoramic sensor, such as a panoramic camera, is a sensor that captures images with elongated fields of view. Panoramic image capture is also known in the art as panoramic photography or wide format photography. According to non-limiting examples, the captured panoramic images can have aspect ratios of 4:1 and sometimes 10:1, covering fields of view of up to 360 degrees at each observation point. In another implementation, the image capture system is a plurality of cameras whose combined images provide wide-angle coverage. A non-limiting example of using a plurality of cameras is the case where four cameras are used to capture four images, one image in each compass direction, at each observation point. Note that the size of the image can vary depending on the application of the system and type of image capture system implemented.

A navigation system 604 is configured to provide location and orientation information. The navigation system can be a pre-existing system on the vehicle, a separate system that is installed on the vehicle, or a remote system that provides location and orientation information to the vehicle. A variety of navigation devices can be used depending on the application of the system. In one implementation, the navigation system includes an inertial navigation system (INS). An INS can provide relative location and orientation information between observation points. INS information facilitates system operation without the system needing to know its location relative to an external, or global, reference. In another implementation, the navigation system includes a global positioning system (GPS) based device. In another implementation, the navigation system provides geospatial data for determining location and orientation information. According to a non-limiting example, the geospatial data is provided as a geotag. Geotag data usually consists of latitude and longitude coordinates, though geotags can include altitude, bearing, accuracy data, and place names.

The image capture system 602, and navigation system 604, are operationally connected to a processing system 606. The processing system includes one or more processors 608 configured with one or more processing modules 610. The processing system 608 is configured to generate observation datasets. An observation dataset includes at least one image from the image capture system, and information from the navigation system used to provide the location at which the image(s) were captured, and the orientation of each image. Observation datasets are captured in accordance with the application of the system. In one implementation, observation datasets are captured periodically based on the system implementation or circumstances of use. In other implementations, observation datasets are captured based on pre-determined events, system learning, or manually triggered. An observation dataset is also captured when an event of interest occurs. Triggering the capture of an observation dataset when an event of interest occurs can be done manually or automatically. Automatic sensing of an event of interest depends on the specific application of the system. In one implementation, images are continuously captured and image processing searches for features that indicate an event of interest. In another implementation, the sensing of an event of interest, such as a muzzle flash, is performed by a separate sensor, possibly operating in a different range of wavelengths from the image capture device. Information from the image capture system and navigation system are used to generate the required information for the observation dataset.

Observation datasets are sent to an observation log in a storage component on the system 612. Depending on the application of the system, storage can be volatile memory associated with the processor, non-volatile memory operationally connected to the processing system, or a combination of implementations. Other storage options and combinations will be obvious to one skilled in the art. In a preferred implementation, the observation log is a database. Databases are known in the art and the specific type of database and implementation options will be obvious to one skilled in the art. In one implementation, images are provided by a vehicle mounted image capture device and the observation log is updated with new observation datasets as the scene around the vehicle changes.

The processing system 608 is configured with one or more processing modules 610 to implement the methods described above to estimate the range to a target. In cases where a prior observation dataset cannot be provided from the observation log to estimate the range to a target, the described system supports calculating the range to the target in combination with a digital terrain map (DTM). It should be appreciated that this system can also be used to support standalone methods for determining an accurate location of an observation dataset on a DTM. In one implementation, the DTM is stored on the system storage 612 and accessed by the processing system 606 as necessary.

Note that the system can include multiple devices to provide the described components or some of the components can provide more than one described capability. According to a non-limiting example, the storage is supplied as a part of the processing system. According to another non-limiting example, the processing may be implemented in the image capture system. According to another non-limiting example, copies of the observation datasets are transmitted from the vehicle to another location for storage. Other variations are possible given current and future technology and will be obvious to one skilled in the art.

It will be appreciated that the above descriptions are intended only to serve as examples, and that many other embodiments are possible within the scope of the present invention as defined in the appended claims.

What is claimed is:

1. A method for estimating the range to a target comprising:
(a) providing an observation log comprising a plurality of observation datasets, each of said observation datasets comprising:
(i) at least one image;
(ii) the location at which said at least one image was captured; and
(iii) the orientation of each of said at least one image;
(b) identifying a target in an image corresponding to a first observation dataset;
(c) searching said observation log for a prior observation dataset, wherein an image of said prior observation dataset includes the target; and
(d) calculating, using data from said first observation dataset in combination with data from said prior observation dataset, using triangulation to estimate the range between the location of said first observation dataset and the target.

2. The method of claim 1 wherein each said observation dataset further comprises the time that the dataset was captured.

3. The method of claim 1 wherein said observation log is searched backwards in time starting with the most recent observation dataset.

4. The method of claim 1 further comprising, when said searching fails to identify a prior observation dataset, calculating the range to the target in combination with a digital terrain map (DTM).

5. The method of claim 1 wherein the images are provided by a vehicle mounted image capture device and said observation log is updated with new observation datasets as the scene around said vehicle changes.

6. A system for estimating the range to a target comprising:
(a) a vehicle;
(b) an image capture system including at least one image capture device configured to provide images, said image capture system mounted on said vehicle;
(c) a navigation system configured to provide location and orientation information; and
(d) a processing system, operationally connected to said image capture system and operationally connected to said navigation system, said processing system including at least one processor configured to:
(i) generate observation datasets comprising:
(A) at least one image;
(B) the location at which said at least one image was captured; and
(C) the orientation of each of said at least one image;
(ii) store observation datasets to an observation log;
(iii) identify a target in an image corresponding to a first observation dataset;
(iv) search said observation log for a prior observation dataset, wherein an image of said prior observation dataset includes the target; and
(v) calculate, using data from said first observation dataset in combination with data from said prior observation dataset, using triangulation to estimate the range between the location of said first observation dataset and the target.

7. The system of claim 6 wherein said image capture device is a panoramic camera.

8. The system of claim 6 wherein said image capture device is a charge coupled device (CCD).

9. The system of claim 6 wherein said image capture device is a forward-looking infrared device (FLIR).

10. The system of claim 6 wherein said navigation system provides said location and orientation information as geospatial data.

11. The system of claim 6 wherein said navigation system comprises an inertial navigation system (INS).

12. The system of claim 6 wherein said navigation system comprises a global positioning system (GPS) based device.

13. The system of claim 6 wherein said observation dataset further comprises the time that the dataset was captured.

14. The system of claim 6 wherein said at least one processor is further configured to search said observation log backwards in time starting with the most recent observation dataset.

15. The system of claim 6 wherein said at least one processor is further configured, when said searching fails to identify a prior observation dataset, to calculate the range to the target in combination with a digital terrain map (DTM).

16. The system of claim 6 wherein said vehicle is configured with an image capture device and said processing system is further configured to update said observation log with new observation datasets as the scene around said vehicle changes.

17. The system of claim 6 further configured to determine an accurate location of an observation dataset on a digital terrain map, comprising:
(a) a digital terrain map; and
(b) said processing system further configured to:
(i) select at least one ranging location in an image from said first observation dataset;
(ii) search said observation log to provide at least one prior observation dataset, wherein an image which corresponds to each of said at least one prior observation datasets includes at least one common identifiable area; and
(iii) calculate using triangulation to determine an accurate location of said first observation dataset on said digital terrain map using a combination of data from said first observation dataset, data from said at least one prior observation dataset, said common identifiable area, and a digital terrain map.

18. The system of claim 17 wherein selecting said at least one ranging location in the image is done randomly.

19. The system of claim 17 wherein selecting said at least one ranging location in the image is done using a sparse distribution.

20. The system of claim 17 wherein selecting said at least one ranging location in the image is done using a dense distribution of a plurality of ranging locations.

21. The system of claim 17 wherein the processing is repeated to substantially constantly maintain the accurate location of said observation dataset on said digital terrain map.

22. The system of claim 17 further configured to:
(a) generate a target vector from the location of said first observation dataset toward the target; and
(b) calculate, using said target vector from said location of said first observation dataset in combination with said digital terrain map, the estimated range between the location of said first observation dataset and the target.

23. A method to determine an accurate location of an observation dataset on a digital terrain map, the method comprising:
(a) providing an observation log comprising a plurality of observation datasets, each of said observation datasets comprising:
at least one image;
(ii) the location at which said at least one image was captured; and
(iii) the orientation of each of said at least one image;
(b) selecting at least one ranging location in an image from a first observation dataset;
(c) searching said observation log to provide at least one prior observation dataset, wherein an image which corresponds to each of said at least one prior observation datasets includes at least one common identifiable area; and
(d) calculating using triangulation to determine an accurate location of said first observation dataset on said digital terrain map using a combination of data from said first observation dataset, data from said at least one prior observation dataset, said common identifiable area, and a digital terrain map.

24. The method of claim 23 wherein said observation dataset further comprises the time that the dataset was captured.

25. The method of claim 23 wherein said observation log is searched backwards in time starting with the most recent observation dataset.

26. The method of claim 23 wherein selecting said at least one ranging location in the image is done randomly.

27. The method of claim 23 wherein selecting said at least one ranging location in the image is done using a sparse distribution.

28. The method of claim 23 wherein selecting said at least one ranging location in the image is done using a dense distribution of a plurality of ranging locations.

29. The method of claim 23 wherein the method is repeated to substantially constantly maintain the accurate location of said observation dataset on said digital terrain map.

30. The method of claim 23 further comprising:
(a) identifying a target in the image corresponding to said first observation dataset;
(b) generating a target vector from the location of said first observation dataset toward the target; and
(c) calculating, using said target vector from said location of said first observation dataset in combination with said digital terrain map, the estimated range between the location of said first observation dataset and the target.

31. A method to determine an accurate location of an observation point on a digital terrain map, the method comprising:
(a) determining a plurality of ranges from an observation point to ranging locations, thereby creating a range map; and
(b) correlating said range map to the digital terrain map to determine an accurate location of the observation point on said digital terrain map.

32. The method of claim 31 wherein said plurality of ranges is a sparse distribution of ranges.

33. The method of claim 31 wherein said plurality of ranges is a dense distribution of ranges.

34. The method of claim 31 further comprising:
(a) generating a target vector from the observation point toward a target; and
(b) calculating, using said target vector from the observation point in combination with the digital terrain map, the estimated range between the observation point and said target.

35. The method of claim 31 wherein said ranges are determined using a range finding device.
